(19) United States
(12) Patent Application Publication
(10) Pub. No.: US 2026/0179985 A1
(43) Pub. Date: Jun. 25, 2026

(54) FUEL CELL SYSTEM

(71) Applicant: TOYOTA JIDOSHA KABUSHIKI KAISHA, Toyota-shi Aichi-ken (JP)

(72) Inventor: Ayuka OHTA MATSUGAMI, Toyota-shi Aichi-ken (JP)

(73) Assignee: TOYOTA JIDOSHA KABUSHIKI KAISHA, Toyota-shi Aichi-ken (JP)

(21) Appl. No.: 19/423,241

(22) Filed: Dec. 17, 2025

(30) Foreign Application Priority Data
Dec. 25, 2024 (JP) 2024-228092

(51) Int. Cl. H01M 8/04746; H01M 8/04029; H01M 8/04223; H01M 8/04302; H01M 8/0432; H01M 8/0438; H01M 8/04537; H01M 8/04858; H01M 8/10

(52) U.S. Cl. CPC H01M 8/04768; H01M 8/04029; H01M 8/04253; H01M 8/04302; H01M 8/0432; H01M 8/04417; H01M 8/04552; H01M 8/0494; H01M 2008/1095; H01M 2250/20

(57) ABSTRACT

A fuel cell system includes: a plurality of fuel cell stacks; at least one supply source that supplies a fluid to the plurality of fuel cell stacks; a distributor that distributes the fluid supplied from the at least one supply source to each fuel cell stack of the plurality of fuel cell stacks in response to a distribution ratio; and a controller. The controller calculates a remaining life of each of the fuel cell stacks and determines the distribution ratio on the basis of the calculated remaining life.

### CROSS REFERENCE TO RELATED APPLICATIONS

The present application claims priority from Japanese patent application 2024-228092 filed on Dec. 25, 2024, the disclosure of which is hereby incorporated in its entirety by reference into the present application.

### BACKGROUND

### Field

The present disclosure relates to a fuel cell system.

### Related Art

A control method suitable for a fuel cell system with a plurality of fuel cell stacks has been under study (Japanese Patent Application Publication No. 2024-030586, for example).

In a fuel cell system with a plurality of fuel cell stacks, variations in remaining life between the fuel cell stacks are desirably small. This brings about the need to reduce variations in remaining life.

### SUMMARY

The present disclosure is feasible in the following aspects.

According to an aspect of the present disclosure, a fuel cell system is provided. The fuel cell system comprises: a plurality of fuel cell stacks; at least one supply source that supplies a fluid to the plurality of fuel cell stacks; a distributor that distributes the fluid supplied from the at least one supply source to each fuel cell stack of the plurality of fuel cell stacks in response to a distribution ratio; and a controller. The controller calculates a remaining life of each of the fuel cell stacks and determines the distribution ratio on the basis of the calculated remaining life.

### BRIEF DESCRIPTION OF THE DRAWINGS

FIG. 1 is a view showing a schematic configuration of a fuel cell system to be mounted on a vehicle;

FIG. 2 is a view showing positions of attachment of various types of sensors;

FIG. 3 is a block diagram showing the configurations of a controller and distributors;

FIG. 4 is a view explaining stress information;

FIG. 5 is a flowchart of processing at the start of operation; and

FIG. 6 is a flowchart of processing during usual operation.

### DETAILED DESCRIPTION

### A. Embodiment

### a1. Configuration of Fuel Cell System:

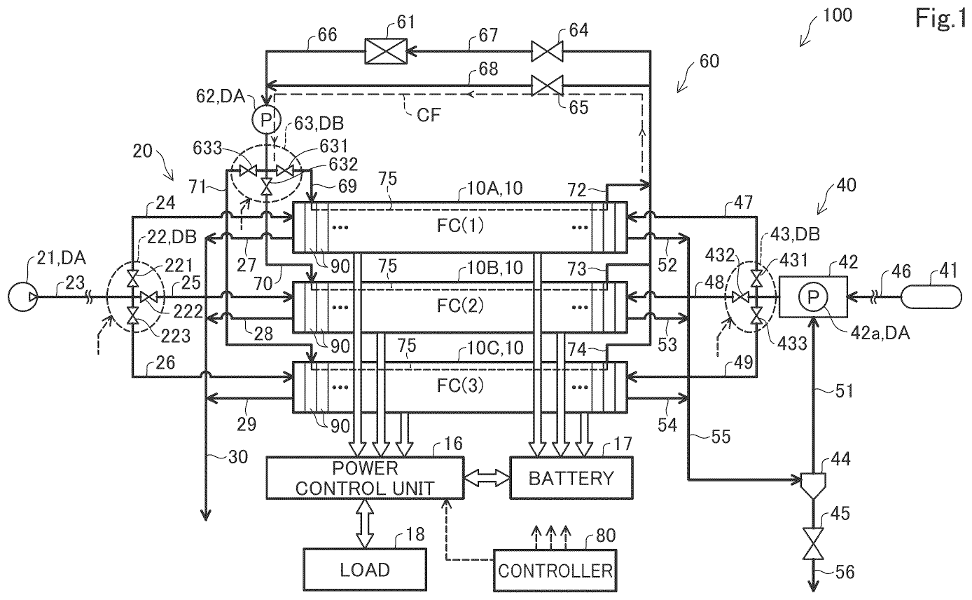

FIG. 1 is a view showing a schematic configuration of a fuel cell system 100 to be mounted on a vehicle. The fuel cell system 100 includes a plurality of fuel cell stacks 10, an oxidizing gas-based circuit 20, a fuel gas-based circuit 40, a cooling-based circuit 60, a power control unit 16, a battery 17, a load 18, and a controller 80. In the present embodiment, the plurality of fuel cell stacks 10 includes a first fuel cell stack 10A, a second fuel cell stack 10B, and a third fuel cell stack 10C. In the present embodiment, the first fuel cell stack 10A, the second fuel cell stack 10B, and the third fuel cell stack 10C are electrically connected in parallel. In the following description, the first fuel cell stack 10A, the second fuel cell stack 10B, and the third fuel cell stack 10C will simply be called “fuel cell stacks 10” if they will not to be distinguished from each other.

The fuel cell stack 10 generates power by causing power generation reaction using a fuel gas and an oxidizing gas. The fuel cell stack 10 is a polymer electrolyte fuel cell and has a stack structure with a plurality of stacked cells 90. The cell 90 has a configuration where a membrane electrode and gas diffusion layer assembly (MEGA) not shown in the drawings is interposed by separators not shown in the drawings. The MEGA includes a membrane electrode assembly (MEA), and gas diffusion layers arranged on both surfaces of the MEA. The MEA includes an electrolyte membrane, an electrode catalyst layer functioning as an anode formed on one of surfaces of the electrolyte membrane, and an electrode catalyst layer functioning as a cathode formed on the other surface of the electrolyte membrane. In the present embodiment, hydrogen is used as the fuel gas and oxygen in air is used as the oxidizing gas. In the following description, the fuel gas and the oxidizing gas may collectively be called a reaction gas.

Power generated by the fuel cell stack 10 is supplied to the power control unit 16 and the battery 17. The power output from the fuel cell stack 10 may be boosted by a DC/DC converter not shown in the drawings. The battery 17 is a secondary battery to be charged with DC power supplied to the battery 17. The power control unit 16 controls the amount of distribution of the power generated by the fuel cell stack 10 to the load 18 and the amount of distribution thereof to the battery 17. The load 18 is a vehicle driving motor, for example.

The oxidizing gas-based circuit 20 is a circuit for supplying air as a fluid to the cathodes of the fuel cell stack 10. The oxidizing gas-based circuit 20 includes an air compressor 21 as an oxidizing gas supply source, an oxidizing gas distributor 22, an oxidizing gas supply main pipe 23, a first oxidizing gas branch pipe 24, a second oxidizing gas branch pipe 25, a third oxidizing gas branch pipe 26, a first oxidizing off-gas discharge pipe 27, a second oxidizing off-gas discharge pipe 28, a third oxidizing off-gas discharge pipe 29, and an oxidizing off-gas discharge main pipe 30.

The air compressor 21 feeds compressed air to the oxidizing gas supply main pipe 23. The oxidizing gas supply main pipe 23 branches into the first oxidizing gas branch pipe 24, the second oxidizing gas branch pipe 25, and the third oxidizing gas branch pipe 26. The first oxidizing gas branch pipe 24 is connected to an oxidizing gas inlet of the first fuel cell stack 10A not shown in the drawings. The second oxidizing gas branch pipe 25 is connected to an oxidizing gas inlet of the second fuel cell stack 10B not shown in the drawings. The third oxidizing gas branch pipe 26 is connected to an oxidizing gas inlet of the third fuel cell stack 10C not shown in the drawings.

In the present embodiment, the oxidizing gas distributor 22 includes a first oxidizing gas valve 221, a second oxidizing gas valve 222, and a third oxidizing gas valve 223. The first oxidizing gas valve 221 is arranged in the first oxidizing gas branch pipe 24. The second oxidizing gas valve 222 is arranged in the second oxidizing gas branch pipe 25. The third oxidizing gas valve 223 is arranged in the third oxidizing gas branch pipe 26. The oxidizing gas distributor 22 adjusts the respective degrees of opening of the first oxidizing gas valve 221, the second oxidizing gas valve 222, and the third oxidizing gas valve 223, thereby adjusting the respective flow rates of the oxidizing gas to be supplied to the first fuel cell stack 10A, the second fuel cell stack 10B, and the third fuel cell stack 10C.

The first oxidizing off-gas discharge pipe 27 is connected to an oxidizing off-gas discharge port of the first fuel cell stack 10A not shown in the drawings. The second oxidizing off-gas discharge pipe 28 is connected to an oxidizing off-gas discharge port of the second fuel cell stack 10B not shown in the drawings. The third oxidizing off-gas discharge pipe 29 is connected to an oxidizing off-gas discharge port of the third fuel cell stack 10C not shown in the drawings. The first oxidizing off-gas discharge pipe 27, the second oxidizing off-gas discharge pipe 28, and the third oxidizing off-gas discharge pipe 29 merge with the oxidizing off-gas discharge main pipe 30. The oxidizing off-gas discharge main pipe 30 communicates with the air, and discharges the oxidizing off-gas discharged from the three fuel cell stacks 10 to the air.

The fuel gas-based circuit 40 is a circuit for supplying the fuel gas as a fluid to the anodes of the fuel cell stack 10. The fuel gas-based circuit 40 includes a fuel gas tank 41, a hydrogen circulator 42, a fuel gas distributor 43, a gas-liquid separator 44, an exhaust-drain valve 45, a fuel gas supply main pipe 46, a first fuel gas branch pipe 47, a second fuel gas branch pipe 48, a third fuel gas branch pipe 49, a first fuel discharge gas pipe 52, a second fuel discharge gas pipe 53, a third fuel discharge gas pipe 54, and a fuel discharge gas main pipe 55.

The fuel gas tank 41 stores high-pressure hydrogen gas. The fuel gas stored in the fuel gas tank 41 is fed to the fuel gas supply main pipe 46. The hydrogen circulator 42 is arranged in the fuel gas supply main pipe 46. The hydrogen circulator 42 includes a circulation pump 42a therein functioning as a fuel gas supply source. The fuel gas supply main pipe 46 branches into the first fuel gas branch pipe 47, the second fuel gas branch pipe 48, and the third fuel gas branch pipe 49. The first fuel gas branch pipe 47 is connected to a fuel gas inlet of the first fuel cell stack 10A not shown in the drawings. The second fuel gas branch pipe 48 is connected to a fuel gas inlet of the second fuel cell stack 10B not shown in the drawings. The third fuel gas branch pipe 49 is connected to a fuel gas inlet of the third fuel cell stack 10C not shown in the drawings.

In the present embodiment, the fuel gas distributor 43 includes a first fuel gas valve 431, a second fuel gas valve 432, and a third fuel gas valve 433. The first fuel gas valve 431 is arranged in the first fuel gas branch pipe 47. The second fuel gas valve 432 is arranged in the second fuel gas branch pipe 48. The third fuel gas valve 433 is arranged in the third fuel gas branch pipe 49. The fuel gas distributor 43 adjusts the respective degrees of opening of the first fuel gas valve 431, the second fuel gas valve 432, and the third fuel gas valve 433, thereby adjusting the respective flow rates of the fuel gas to be supplied to the first fuel cell stack 10A, the second fuel cell stack 10B, and the third fuel cell stack 10C.

The first fuel discharge gas pipe 52 is connected to a fuel off-gas discharge port of the first fuel cell stack 10A not shown in the drawings. The second fuel discharge gas pipe 53 is connected to a fuel off-gas discharge port of the second fuel cell stack 10B not shown in the drawings. The third fuel discharge gas pipe 54 is connected to a fuel off-gas discharge port of the third fuel cell stack 10C not shown in the drawings. The first fuel discharge gas pipe 52, the second fuel discharge gas pipe 53, and the third fuel discharge gas pipe 54 merge with the fuel discharge gas main pipe 55.

The fuel discharge gas main pipe 55 is connected to the gas-liquid separator 44. A back-flow pipe 51 is connected to the gas-liquid separator 44 and the hydrogen circulator 42. A discharge gas pipe 56 is connected to the gas-liquid separator 44. The exhaust-drain valve 45 is arranged in the discharge gas pipe 56.

The fuel off-gas discharged from the fuel off-gas discharge port of each of the three fuel cell stacks 10 is separated into a gaseous component and a liquid component by the gas-liquid separator 44. The exhaust-drain valve 45 switches the discharge gas pipe 56 to a communicable or non-communicable state. The gaseous component in the fuel discharge gas separated by the gas-liquid separator 44 is returned to the fuel gas supply main pipe 46 by the hydrogen circulator 42. This achieves reuse of unreacted hydrogen contained in the fuel off-gas. If a gaseous component in the fuel off-gas other than the hydrogen gas increases in concentration, the exhaust-drain valve 45 is opened to discharge the liquid component and the fuel off-gas to the outside.

The cooling-based circuit 60 is a circuit for adjusting a temperature at the fuel cell stack 10 by circulating cooling water as a fluid. The cooling-based circuit 60 includes a radiator 61, a circulation pump 62 as a cooling water supply source, a cooling water supply main flow path 66, a cooling water discharge main flow path 67, a bypass flow path 68, a first valve 64, a second valve 65, a first cooling water branch flow path 69, a second cooling water branch flow path 70, a third cooling water branch flow path 71, a first cooling water discharge flow path 72, a second cooling water discharge flow path 73, and a third cooling water discharge flow path 74.

A cooling water manifold 75 for passage of the cooling water is formed inside the fuel cell stack 10. In the present embodiment, the cooling water manifold 75 has a configuration where a cooling water manifold for supply and a cooling water manifold for discharge are connected to each other via a cooling water flow path in the cells 90. In FIG. 1, the cooling water manifold 75 is schematically illustrated by dashed lines. The cooling water supply main flow path 66 is connected to an outlet of the radiator 61.

The cooling water supply main flow path 66 branches into the first cooling water branch flow path 69, the second cooling water branch flow path 70, and the third cooling water branch flow path 71. The first cooling water branch flow path 69 is connected to the cooling water manifold for supply in the first fuel cell stack 10A not shown in the drawings. The second cooling water branch flow path 70 is connected to the cooling water manifold for supply in the second fuel cell stack 10B not shown in the drawings. The third cooling water branch flow path 71 is connected to the cooling water manifold for supply in the third fuel cell stack 10C not shown in the drawings.

In the present embodiment, a cooling water distributor 63 includes a first cooling water valve 631, a second cooling water valve 632, and a third cooling water valve 633. The first cooling water valve 631 is arranged in the first cooling water branch flow path 69. The second cooling water valve 632 is arranged in the second cooling water branch flow path 70. The third cooling water valve 633 is arranged in the third cooling water branch flow path 71. The cooling water distributor 63 adjusts the respective degrees of opening of the first cooling water valve 631, the second cooling water valve 632, and the third cooling water valve 633, thereby adjusting the respective flow rates of the cooling water to be supplied to the first fuel cell stack 10A, the second fuel cell stack 10B, and the third fuel cell stack 10C.

The first cooling water discharge flow path 72 is connected to the cooling water manifold for discharge in the first fuel cell stack 10A not shown in the drawings. The second cooling water discharge flow path 73 is connected to the cooling water manifold for discharge in the second fuel cell stack 10B not shown in the drawings. The third cooling water discharge flow path 74 is connected to the cooling water manifold for discharge in the third fuel cell stack 10C not shown in the drawings. The first cooling water discharge flow path 72, the second cooling water discharge flow path 73, and the third cooling water discharge flow path 74 merge with the cooling water discharge main flow path 67.

The circulation pump 62 is arranged in the cooling water supply main flow path 66. Using air blown from an electrically-driven fan not shown in the drawings, for example, the radiator 61 cools the cooling water having flowed therein from the cooling water discharge main flow path 67 via an inlet, and discharges the resultant cooling water via the outlet thereof to the cooling water supply main flow path 66.

The bypass flow path 68 is a flow path branching from the cooling water discharge main flow path 67 and merging with the cooling water supply main flow path 66. The second valve 65 is arranged in the bypass flow path 68. The first valve 64 is arranged in the cooling water discharge main flow path 67. A flow path along which the cooling water circulates while passing through the bypass flow path 68 without passing through the radiator 61 is called a circulation flow path CF.

By adjusting the respective degrees of opening of the first valve 64 and the second valve 65, the flow rate of the cooling water to pass through the radiator 61 and the flow rate of the cooling water to pass through the circulation flow path CF are adjusted. By opening the second valve 65 fully and closing the first valve 64 fully during warm-up operation described later, for example, the cooling water having flowed from the cooling water manifold in the fuel cell stack 10 into the cooling water discharge main flow path 67 travels toward the bypass flow path 68 instead of traveling toward the radiator 61. By doing so, the cooling water circulates through the circulation flow path CF without being cooled by the radiator 61.

In the following description, the oxidizing gas, the fuel gas, and the cooling water may also be called a fluid collectively. The air compressor 21, the circulation pump 42a, and the circulation pump 62 may also be called a supply source DA collectively. The oxidizing gas distributor 22, the fuel gas distributor 43, and the cooling water distributor 63 may also be called a distributor DB collectively. In the present disclosure, the supply source DA means a device that feeds the fluid to the fuel cell stack 10.

The fuel cell system 100 of the present embodiment has a configuration where one air compressor 21, one circulation pump 42a, and one circulation pump 62 are provided for the plurality of fuel cell stacks 10, and the fluid is distributed and then supplied to each fuel cell stack 10. The fuel cell system 100 of this configuration is expected to achieve low cost, space saving, and low fuel consumption compared to a configuration including a plurality of the air compressors 21, a plurality of the circulation pumps 42a, and a plurality of the circulation pumps 62.

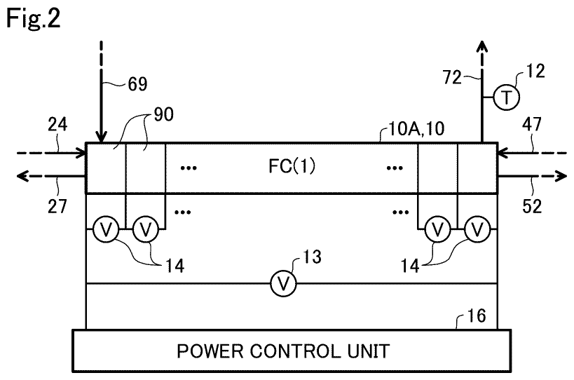

FIG. 2 is a view showing positions of attachment of various types of sensors. The positions of attachment of the sensors in the fuel cell stack 10 are common among the first fuel cell stack 10A, the second fuel cell stack 10B, and the third fuel cell stack 10C. Thus, the first fuel cell stack 10A will be used as a representative for describing the positions of attachment of the sensors.

As shown in FIG. 2, in addition to the above structures, the fuel cell stack 10 includes a temperature sensor 12, a voltage sensor 13, and a plurality of cell voltage sensors 14. The temperature sensor 12 of the first fuel cell stack 10A is provided in the first cooling water discharge flow path 72. The voltage sensor 13 is provided between opposite electrodes of the fuel cell stack 10 and is used for detecting a total voltage at the first fuel cell stack 10A. In the present embodiment, on the basis of one cell 90 as a unit, each of the cell voltage sensors 14 detects a cell voltage showing a voltage at the cell 90. Detected values from the corresponding sensors are transmitted to the controller 80. The cell voltage sensor 14 may be configured to detect a voltage on the basis of two or more cells 90 as a unit. In the present disclosure, the cell voltage means a voltage at one cell 90. In the configuration where the cell voltage sensor 14 detects a voltage on the basis of two or more cells 90 as a unit, an average of detected voltages may be used as the cell voltage.

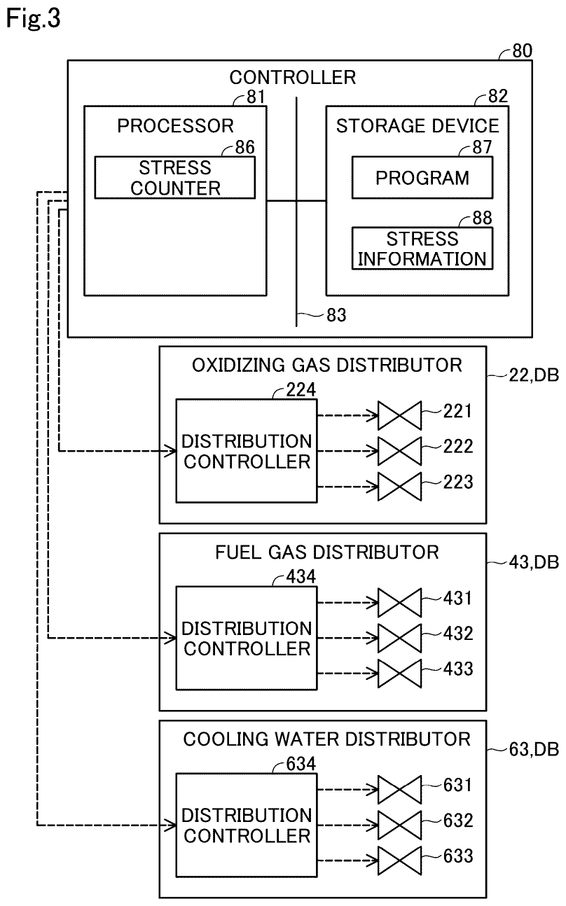

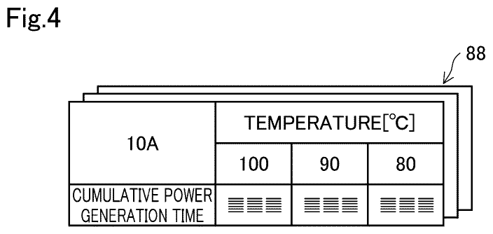

FIG. 3 is a block diagram showing the configuration of the controller 80. FIG. 4 is a view explaining stress information 88. As shown in FIG. 3, the controller 80 is configured as a computer including a processor 81, a storage device 82, and a bus 83. The storage device 82 has a configuration including a ROM or a RAM, for example. The processor 81 includes a stress counter 86. The stress counter 86 is a functional unit realized by execution of a program 87 stored in the storage device 82 by the processor 81. In response to execution of the program 87 by the processor 81, the controller 80 performs processing at the start of operation and processing during usual operation described later, and others. As will be described later in detail, the controller 80 determines an operating point of the fuel cell stack 10, and instructs a distribution ratio to the oxidizing gas distributor 22, the fuel gas distributor 43, and the cooling water distributor 63.

In addition to the above structures, the oxidizing gas distributor 22 includes a distribution controller 224. The distribution controller 224 controls the respective degrees of opening of the first oxidizing gas valve 221, the second oxidizing gas valve 222, and the third oxidizing gas valve 223 in response to the instructed distribution ratio. In addition to the above structures, the fuel gas distributor 43 includes a distribution controller 434. The distribution controller 434 controls the respective degrees of opening of the first fuel gas valve 431, the second fuel gas valve 432, and the third fuel gas valve 433 in response to the instructed distribution. In addition to the above structures, the cooling water distributor 63 includes a distribution controller 634. The distribution controller 634 controls the respective degrees of opening of the first cooling water valve 631, the second cooling water valve 632, and the third cooling water valve 633 in response to the instructed distribution.

The stress counter 86 records a cumulative power generation time [h] in a high-load environment in each of the three fuel cell stacks 10. The high-load environment is an environment where load is higher than load in a predetermined reference environment. In the present embodiment, the reference environment is defined in terms of temperature. More specifically, the reference environment means a range where a temperature at the fuel cell stack 10 is equal to or higher than 0° C. and equal to or less than 70° C. In the present embodiment, a cumulative power generation time during usual operation performed under a condition of a temperature at the fuel cell stack 10 being higher than 70° C. is set as a cumulative power generation time in the high-load environment. In the present embodiment, a detected temperature from the temperature sensor 12 is used as a temperature at the fuel cell stack 10.

More specifically, the stress counter 86 records the stress information 88. As shown in FIG. 4, the stress information 88 is information containing a cumulative power generation time in the fuel cell stack 10 recorded on the basis of each fuel cell stack 10 in a situation where a temperature from the temperature sensor 12 is each of 100° C., 90° C., and 80° C. The temperature of 100° C. specifically means a temperature range of higher than 90° C. and equal to or less than 100° C. The temperature of 90° C. specifically means a temperature range of higher than 80° C. and equal to or less than 90° C. The temperature of 80° C. specifically means a temperature range of higher than 70° C. and equal to or less than 80° C.

The controller 80 instructs the distribution ratio in such a manner that, during power generation after calculation of a remaining life, power generation load on a first fuel cell stack 10 becomes larger than power generation load on a second fuel cell stack 10 having a remaining life shorter than the remaining life of the first fuel cell stack 10. In the present embodiment, the controller 80 instructs the distribution ratio in such a manner that power generation load on the fuel cell stack 10 of the plurality of fuel cell stacks 10 having the longest remaining life becomes larger than power generation load on the fuel cell stack 10 of these fuel cell stacks 10 having the shortest remaining life. In this way, the distribution ratio is controlled in such a manner that power generation load on the fuel cell stack 10 having the longest remaining life becomes larger than power generation load on the fuel cell stack 10 having the shortest remaining life, so that variations in remaining life between the plurality of fuel cell stacks are reduced.

More specifically, the power generation load includes a power generation duration or a power generation amount. In the present embodiment, the fuel cell stacks 10 are controlled in such a manner that a power generation duration in the fuel cell stack 10 having the longest remaining life becomes longer than a power generation duration in the fuel cell stack 10 having the shortest remaining life in order to increase power generation load on the fuel cell stack 10 having the longest remaining life. More specifically, the fuel cell system 100 is configured in such a manner that, when the fuel cell system 100 starts power generation, a warm-up operation start time of the fuel cell stack 10 having the longest remaining life becomes earlier than a warm-up operation start time of the fuel cell stack 10 having the shortest remaining life. When the fuel cell system 100 finishes the power generation, the fuel cell system 100 is controlled in such a manner as to cause the plurality of fuel cell stacks 10 to finish the power generation at the same time.

The storage device 82 contains a lifetime in the reference environment not shown in the drawings and an equivalent lifetime at 100° C. that are stored in advance. The controller 80 contains a cumulative power generation time in the reference environment and an equivalent cumulative power generation time at 100° C. not shown in the drawings that are recorded in the storage device 82. The lifetime in the reference environment and the equivalent lifetime at 100° C. are predetermined periods of time, and are periods of time set commonly between the plurality of fuel cell stacks 10. The lifetime in the reference environment and the equivalent lifetime at 100° C. are convertible to each other using a predetermined coefficient. The equivalent lifetime at 100° C. is shorter than the lifetime in the reference environment. Likewise, the cumulative power generation time in the reference environment and the equivalent cumulative power generation time at 100° C. are convertible to each other using a predetermined coefficient. Each of the cumulative power generation time in the reference environment and the equivalent cumulative power generation time at 100° C. is an accumulated duration of power generation durations in a period from shipment of the fuel cell system 100 up to the present. The cumulative power generation time in the reference environment and the equivalent cumulative power generation time at 100° C. are recorded in association with each of the plurality of fuel cell stacks 10.

### a2. Usual Operation and Warm-Up Operation:

The usual operation and the warm-up operation in the fuel cell stack 10 will be described. During the usual operation, power is generated in response to supply of air equal to or greater than a theoretical air quantity required for generation of target output power. More specifically, the controller 80 determines an operating point indicating an output voltage and an output current in the fuel cell stack 10 for fulfilling requested power. The controller 80 determines a supply amount of the oxidizing gas and a supply amount of the fuel gas for fulfilling the determined operating point. As described above, the controller 80 makes a determination in such a manner that a supply amount of the oxidizing gas becomes equal to or greater than the theoretical air quantity during the usual operation.

During the usual operation, the controller 80 determines the operating point in such a manner that a power generation amount is divided equally among the three fuel cell stacks 10, namely, the three fuel cell stacks 10 have the same operating point unless specified otherwise. Thus, the controller 80 determines a distribution ratio in such a manner that the respective flow rates of the fluid to be supplied from the supply source DA to the first fuel cell stack 10A, the second fuel cell stack 10B, and the third fuel cell stack 10C become equal to each other. Specifically, with the respective flow rates of each fluid to be supplied to the first fuel cell stack 10A, the second fuel cell stack 10B, and the third fuel cell stack 10C defined as “FA1,” “FA2,” and “FA3” respectively, a distribution ratio is set as follows: FA1:FA2:FA3=1:1:1.

During the warm-up operation, in order to reduce operating efficiency, power is generated at an air quantity less than the air quantity supplied during the usual operation. During the warm-up operation, an air stoichiometric ratio is set to about 1.0, for example. The air stoichiometric ratio means a ratio of an air quantity to be actually supplied to the theoretical air quantity required for generation of the target output power. During the warm-up operation, operating the fuel cell stack 10 at a low-efficient operating point increases a concentration overpotential, thereby warming up the fuel cell stack 10 by means of self-heating.

The warm-up operation is mainly performed when an outside air temperature is below the freezing temperature. The temperature below the freezing temperature may cause freezing of water, etc. generated during previous running and remaining in the fuel cell stack 10, and this may partially block the flow path for the fuel gas in the fuel cell stack 10. In response to this, the warm-up operation is performed for ice melting in advance of the usual operation.

The fuel cell system 100 of the present embodiment includes the plurality of fuel cell stacks 10. By starting the fuel cell stack 10 having a long remaining life, the fuel cell stack 10 having the long remaining life makes a transition to the usual operation in advance of the fuel cell stack 10 having a short remaining life. Thus, the fuel cell stack 10 having the long remaining life operates for a longer duration than an operating duration in the fuel cell stack 10 having the short remaining life. In this way, it is possible to reduce variations in remaining life between the plurality of fuel cell stacks 10.

The inventors have confirmed that performing the warm-up operations in the plurality of fuel cell stacks 10 sequentially one by one results in a shorter period of time for reaching maximum output and achieves better fuel efficiency than performing the warm-up operations in these fuel cell stacks 10 simultaneously. In this regard, in the present embodiment, control is exerted in such a manner, for implementation of the warm-up operation, the warm-up operations are performed in the plurality of fuel cell stacks 10 in periods shifted from each other. This makes it possible to shorten a period of time in order for output from the fuel cell system 100 to reach the maximum output and achieve good fuel efficiency, compared to a case where the warm-up operations are performed simultaneously in all the fuel cell stacks 10.

### A3. Processing at the Start of Operation:

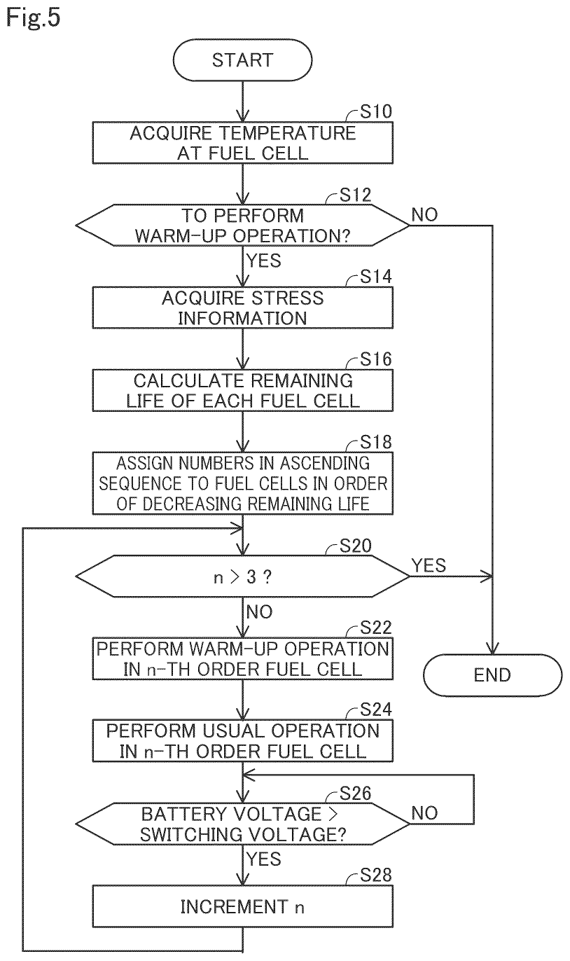

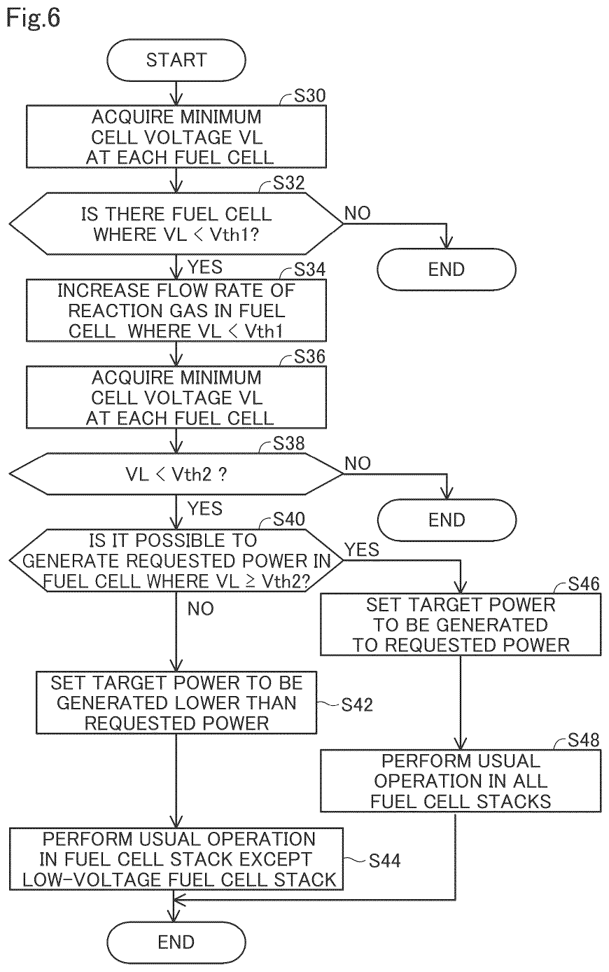

FIG. 5 is a flowchart of processing at the start of operation. In FIG. 5 and FIG. 6 referred to later, a “fuel cell stack” is abbreviated as a “fuel cell.” After being started, the controller 80 performs the processing at the start of operation. In step S10, the controller 80 acquires a temperature at the plurality of fuel cell stacks 10. In the present embodiment, the controller 80 acquires an average of detected temperatures from the respective temperature sensors 12 of the three fuel cell stacks 10 as the temperature at the plurality of fuel cell stacks 10. In the present embodiment, the three fuel cell stacks 10 are arranged at positions close to each other, and the respective temperatures at the three fuel cell stacks 10 are assumed to be substantially equal to each other.

In step S12, the controller 80 judges whether to perform the warm-up operation. More specifically, the controller 80 judges to perform the warm-up operation if the acquired temperature at the fuel cell stack 10 is equal to or less than a predetermined reference temperature. By contrast, the controller 80 judges not to perform the warm-up operation if the acquired temperature at the fuel cell stack 10 is higher than the reference temperature. The reference temperature is about −10° C., for example. If the controller 80 judges not to perform the warm-up operation in step S12, the controller 80 finishes this processing routine.

If the controller 80 judges to perform the warm-up operation in step S12, the controller 80 acquires the stress information 88 stored in the storage device 82 in order to calculate a remaining life in step S14. In step S14, the controller 80 further acquires an equivalent lifetime at 100° C. stored in the storage device 82.

In step S16, the controller 80 calculates the respective remaining lives of the three fuel cell stacks 10 using the acquired stress information 88. More specifically, the controller 80 calculates an equivalent cumulative power generation time ATs at 100° C. using the following formula (1):

ATs=PT(80)×a+PT(90)×b+PT(100) (1)

Referring to the formula (1), PT (80) is a cumulative power generation time at 80° C. PT (90) is a cumulative power generation time at 90° C. PT (100) is a cumulative power generation time at 100° C. The coefficient a is a coefficient determined in advance for converting the cumulative power generation time at 80° C. to the cumulative power generation time at 100° C. The coefficient b is a coefficient determined in advance for converting the cumulative power generation time at 90° C. to the cumulative power generation time at 100° C. The coefficient a and the coefficient b are less than 1. The coefficient b is larger than the coefficient a. Next, the controller 80 subtracts the equivalent cumulative power generation time ATs at 100° C. from an equivalent lifetime at 100° C., thereby calculating the remaining life. Specifically, in the present embodiment, the remaining life indicates a cumulative power generation time where power generation is possible in the future in the high-load environment.

In the present embodiment, a cumulative power generation time in the reference environment, a cumulative power generation time in a temperature environment less than 0° C., or an operation accumulated duration of the warm-up operation is not used for calculating the remaining life. In another embodiment, a cumulative power generation time in the reference environment may be converted to a cumulative power generation time at 100° C., corresponding values of the converted cumulative power generation time at 100° C. and the cumulative power generation time in the reference environment may be subtracted from a lifetime at 100° C., and a duration thereby determined may be used as the remaining life, for example. By doing so, it becomes possible to obtain the remaining life more correctly. In another case, a cumulative power generation time in a temperature environment less than 0° C. and an operation accumulated duration of the warm-up operation may be recorded in the storage device 82, and the remaining life may be calculated using the cumulative power generation time in the temperature environment less than 0° C. and the operation accumulated duration of the warm-up operation like in the calculation method using the cumulative power generation time in the reference environment.

In step S18, the controller 80 assigns numbers in ascending sequence to the fuel cell stacks 10 in order of decreasing remaining life. As a specific example, if the first fuel cell stack 10A has the longest remaining life and the third fuel cell stack 10C has the shortest remaining life, numbers are assigned such that the first fuel cell stack 10A is number one, the second fuel cell stack 10B is number two, and the third fuel cell stack 10C is number three. Furthermore, the controller 80 sets a variable n used in this processing routine to 1 as a default value.

In step S20, the controller 80 judges whether the variable n is greater than 3. If step S20 is performed for the first time after start of the processing at the start of operation, the variable n is judged not to be greater than 3 in step S20. If the variable n is judged not to be greater than 3 in step S20, the controller 80 starts the warm-up operation in the nth-order (the number n) fuel cell stack 10 in step S22. More specifically, the controller 80 instructs a distribution ratio to each of the oxidizing gas distributor 22, the fuel gas distributor 43, and the cooling water distributor 63 in such a manner as to supply the oxidizing gas, the fuel gas, and the cooling water to the nth-order fuel cell stack 10. During the warm-up operation in the first-order fuel cell stack 10, control is exerted in such a manner that the oxidizing gas, the fuel gas, and the cooling water are not supplied to the other fuel cell stacks 10. Specifically, the controller 80 sets the ratio of the oxidizing gas to be supplied to the first-order (the number one) fuel cell stack 10 to “1” and sets the ratios of the oxidizing gas to be supplied to the other two fuel cell stacks 10 to “0.” The controller 80 makes the setting in the same way for the respective ratios of the fuel gas and the cooling water. By doing so, the cooling water increased in temperature by the first-order fuel cell stack 10 performing the warm-up operation is caused to circulate only in the first-order fuel cell stack 10. As a result, it becomes possible to warm up the first-order fuel cell stack 10 efficiently.

In step S24, the controller 80 switches the operation in the first-order fuel cell stack 10 from the warm-up operation to the usual operation. In the present embodiment, the controller 80 performs step S24 if a detected temperature in the nth-order fuel cell stack 10 becomes equal to or greater than a predetermined switching temperature.

In step S26, the controller 80 judges whether a battery voltage corresponding to a detected voltage from the voltage sensor 13 in the nth-order fuel cell stack 10 is greater than a predetermined switching voltage. If the battery voltage is judged not to be greater than the switching voltage in step S26, the controller 80 returns the processing flow to step S26 after passage of a predetermined period of time. If the battery voltage is judged to be greater than the switching voltage in step S26, the nth-order fuel cell stack 10 is in a state of generating power stably. Thus, in step S28, the controller 80 increments the variable n and returns the processing flow to step S20. The switching voltage has a value that is 80% of a theoretical power generation voltage in the fuel cell stack 10, for example. The predetermined period of time is some milliseconds, for example.

For implementation of the warm-up operation in the second-order (the number two) fuel cell stack 10 and its subsequent fuel cell stack 10, the controller 80 starts the warm-up operation while performing the usual operation in the fuel cell stack 10 where the usual operation has already been performed previously. If the variable n is judged to be greater than 3 in step S20, the controller 80 finishes this processing routine.

### a4. Processing During Usual Operation:

FIG. 6 is a flowchart of the processing during usual operation. During the usual operation, generated water resulting from power generation reaction may be retained in the flow path for the fuel gas or in the flow path for the oxidizing gas in the fuel cell stack 10. In such a case, pressure loss of the reaction gas increases. This makes an actual supply amount of the reaction gas smaller than a target supply amount of the reaction gas, resulting in the occurrence of the cell 90 not making power generation reaction. In the cell 90 not making power generation reaction, compared to a target cell voltage, an actual cell voltage is reduced and typically becomes a negative voltage. In response to this, in the processing during usual operation, the fuel gas and the oxidizing gas are supplied abundantly to the fuel cell stack 10 where reduction in the cell voltage occurs in order to remove the retained generated water. In FIG. 6, a “low-voltage fuel cell stack” described later is abbreviated as a “low-voltage fuel cell.”

During implementation of the usual operation, the controller 80 performs the processing during usual operation repeatedly. In step S30, the controller 80 acquires a minimum cell voltage VL in each fuel cell stack 10. In step S32, the controller 80 judges the presence of the fuel cell stack 10 where the minimum cell voltage VL is lower than a first reference voltage Vth1. The fuel cell stack 10 where the minimum cell voltage VL is lower than the first reference voltage Vth1 is also called a low-voltage fuel cell stack. If it is judged in step S32 that there is no fuel cell stack 10 where the minimum cell voltage VL is lower than the first reference voltage Vth1, the controller 80 finishes this processing routine.

If it is judged in step S32 that there is a fuel cell stack 10 where the minimum cell voltage VL is lower than the first reference voltage Vth1, the controller 80 increases the flow rate of the oxidizing gas and the flow rate of the fuel gas in the low-voltage fuel cell stack in step S34. Step S34 is a processing step intended to blow away and remove the generated water remaining in the cell 90 using the reaction gas. Step S34 is also called a purging process. In some cases, even performing the scavenging process still fails to sufficiently remove the generated water remaining in the cell 90.

In the present embodiment, the flow rate of the reaction gas is increased in step S34 in such a manner as to make the flow rate of the reaction gas larger by a predetermined rate than the flow rate of the reaction gas at a reference operating point. In the present embodiment, a distribution ratio is adjusted in such a manner as to make the supply source DA increase the flow rate of the reaction gas to be fed to the fuel cell stack 10, to increase the flow rate of the gas to be supplied to the low-voltage fuel cell stack, and to keep the flow rate of the gas unchanged to be supplied to the fuel cell stack 10 other than the low-voltage fuel cell stack.

In step S36, the controller 80 acquires the minimum cell voltage VL in each fuel cell stack 10. In step S38, the controller 80 judges the presence of the fuel cell stack 10 where the minimum cell voltage VL is lower than a second reference voltage Vth2. In the present embodiment, the second reference voltage Vth2 is set to a value smaller than the first reference voltage Vth1. If performing the scavenging process still fails to sufficiently remove the generated water remaining in the cell 90, it is impossible to cause the low-voltage fuel cell stack to generate power. The second reference voltage Vth2 is a threshold for judging the capability of the fuel cell stack 10 to generate power. As an example, the first reference voltage Vth1 is about 0.2 V and the second reference voltage Vth2 is about 0.0 V. By setting the first reference voltage Vth1 to a larger value than the second reference voltage Vth2, it becomes possible to perform the scavenging process in advance before the generated water is retained in the cell 90 to a level that disables the cell 90 to generate power.

If it is judged in step S38 that there is a fuel cell stack 10 where the minimum cell voltage VL is lower than the second reference voltage Vth2, the controller 80 judges in step S40 whether it is possible to generate requested power in the fuel cell stack 10 where the minimum cell voltage VL is equal to or greater than the second reference voltage Vth2.

If it is judged in step S40 that it is not possible to generate the requested power in the fuel cell stack 10 where the minimum cell voltage VL is equal to or greater than the second reference voltage Vth2, the controller 80 sets maximum power as a target power generation amount in step S42 that is capable of being generated in the fuel cell stack 10 where the minimum cell voltage VL is equal to or greater than the second reference voltage Vth2. In this case, the target power generation amount is smaller than the requested power. In step S44, the controller 80 causes the fuel cell stack 10 except the low-voltage fuel cell stack to perform the usual operation in order to generate power to the target power generation amount. More specifically, the controller 80 adjusts the flow rate of the fuel gas and the flow rate of the oxidizing gas in such a manner as to make the respective flow rates of the fuel gas, the oxidizing gas, and the cooling water zero to be supplied to the low-voltage fuel cell stack and to supply the fuel gas, the oxidizing gas, and the cooling water to the other fuel cell stack 10. More specifically, the controller 80 determines a flow rate at each supply source DA about the fluid to be fed to the fuel cell stack 10 and determines a distribution ratio at the distributor DB. After implementation of step S44, the controller 80 finishes this processing routine.

If it is judged in step S40 that it is possible to generate the requested power in the fuel cell stack 10 where the minimum cell voltage VL is equal to or greater than the second reference voltage Vth2, the controller 80 sets the requested power as a target power generation amount in step S46. In step S48, the controller 80 causes all the fuel cell stacks 10 to perform the usual operation in order to generate power to the target power generation amount. After implementation of step S48, the controller 80 finishes this processing routine.

According to the embodiment described above, the fuel cell system 100 includes the plurality of fuel cell stacks 10, the supply source DA, the distributor DB, and the controller 80. The controller 80 calculates the remaining life of each fuel cell stack 10, and determines a distribution ratio at the distributor DB using the calculated remaining life. In the present embodiment, the controller 80 determines the distribution ratio in such a manner that power generation load on the fuel cell stack 10 of the plurality of fuel cell stacks 10 having the longest remaining life becomes larger than power generation load on the fuel cell stack 10 of these fuel cell stacks 10 having the shortest remaining life. More specifically, the controller 80 determines the distribution ratio in such a manner that a power generation start time of the fuel cell stack 10 having the longest remaining life becomes earlier than a power generation start time of the fuel cell stack 10 having the shortest remaining life. In the present embodiment, the controller 80 starts the warm-up operation sequentially from the first-order fuel cell stack 10 having the longest remaining life by supplying the fuel gas and the oxidizing gas. The fuel cell stack 10 performing the warm-up operation makes a transition to the usual operation in response to temperature increase in the fuel cell stack 10. Thus, a power generation duration in the fuel cell stack 10 having a long remaining life becomes longer than a power generation duration in the fuel cell stack 10 having a short remaining life. This makes it possible to reduce a difference between the remaining life of the fuel cell stack 10 having the long remaining life and the remaining life of the fuel cell stack 10 having the short remaining life, thereby achieving reduction in variations in remaining life.

The controller 80 exerts control in such a manner that, when the warm-up operation is started in the first-order fuel cell stack 10 having the longest remaining life, the warm-up operation is not performed in the second-order fuel cell stack 10 and its subsequent fuel cell stack 10 and the cooling water increased in temperature by the first-order fuel cell stack 10 performing the warm-up operation is caused to circulate only in the first-order fuel cell stack 10. By doing so, it becomes possible to warm up the first-order fuel cell stack 10 efficiently.

In the presence of the low-voltage fuel cell stack where a cell voltage is lower than the first reference voltage during the usual operation, the controller 80 determines a distribution ratio in such a manner as to make the flow rate of the oxidizing gas and the flow rate of the fuel gas to be supplied to the low-voltage fuel cell stack larger than the corresponding flow rates at a reference operating point. By doing so, it becomes possible to remove generated water retained in the flow path for the fuel gas in the fuel cell stack 10 or the flow path for the oxidizing gas in the fuel cell stack 10.

### B. Other Embodiments

(B1) In the above embodiment, a power generation duration is adjusted in such a manner as to impose large power load on the fuel cell stack 10 having a long remaining life. In another embodiment, the amount of power may be adjusted as power load. If requested power is smaller than maximum output from the fuel cell system 100, for example, control may be exerted in such a manner as to make target power in the fuel cell stack 10 having a long remaining life larger than target power in the fuel cell stack 10 having a short remaining life. In this embodiment, the stress counter 86 may record a cumulative power generation time in each fuel cell stack 10 on the basis of each predetermined range of output power.
(B2) In the above embodiment, control is exerted in such a manner that, by starting the warm-up operation in the first-order fuel cell stack 10 in advance, an operating duration in the first-order fuel cell stack 10 becomes longer than an operating duration in the second-order fuel cell stack 10. In another embodiment, control may be exerted in such a manner that, if the usual operation is to be started without performing the warm-up operation, the usual operation is started in the fuel cell stack 10 having a long remaining life during the usual operation. Specifically, the control of shifting operation start times in the plurality of fuel cell stacks 10 from each other may be exerted in only one of the usual operation and the warm-up operation, or in both of the usual operation and the warm-up operation.
(B3) In the above embodiment, in the processing at the start of operation, the warm-up operation and the usual operation are started in order of decreasing remaining life. In another embodiment, in the presence of four or more fuel cell stacks 10, the first-order fuel cell stack 10 may start the warm-up operation earlier than the second-order fuel cell stack 10, and the third-order fuel cell stack 10 and its subsequent fuel cell stack 10 may start the warm-up operation simultaneously with each other in order of decreasing remaining life, for example. In another case, the first-order fuel cell stack 10 may start the warm-up operation earlier than the fuel cell stack 10 having the shortest remaining life, and the other fuel cell stacks 10 may start the warm-up operation simultaneously with each other. By causing the fuel cell stack 10 of at least two of the plurality of fuel cell stacks 10 having a long remaining life to start the warm-up operation earlier, it becomes possible to reduce variations in remaining life.
(B4) In the above embodiment, for implementation of the warm-up operation in the first-order fuel cell stack 10, the flow rate of the fluid to be supplied to the fuel cell stack 10 other than the first-order fuel cell stack 10 is adjusted to zero. In another embodiment, the fluid may be supplied to the fuel cell stack 10 other than the first-order fuel cell stack 10 at a flow rate lower than the flow rate of the fluid to be supplied to the first-order fuel cell stack 10.
(B5) In the above embodiment, it is stated that, in the processing during usual operation, a cell voltage is reduced by retention of generated water in the flow path inside the fuel cell stack 10. Insufficient supply of the fuel gas becomes a different cause for cell voltage reduction. In this case, performing the above processing during usual operation also makes it possible to recover the cell voltage. Reason for this is that, as the insufficient fuel gas is detected as cell voltage reduction, a supply amount of the fuel gas is increased. The occurrence of the insufficient fuel gas causes deterioration of an electrode catalyst layer. In response to this, performing the processing during usual operation makes it possible to suppress the deterioration of the electrode catalyst layer.
(B6) In the above embodiment, in step S34 of the processing during usual operation, control is exerted in such a manner as to increase the flow rate of the reaction gas to be fed from the supply source DA to the fuel cell stack 10. In another embodiment, control may be exerted in such a manner as to increase the flow rate of the reaction gas to be supplied to the low-voltage fuel cell stack and reduce the flow rate thereof to be supplied to the other fuel cell stack 10 by changing only a distribution ratio while leaving the flow rate of the reaction gas to be fed from the supply source DA to the fuel cell stack 10 unchanged.
(B7) In the above embodiment, the oxidizing gas distributor 22 includes the first oxidizing gas valve 221, the second oxidizing gas valve 222, and the third oxidizing gas valve 223. The configuration of the oxidizing gas distributor 22 is not limited to the above. As an example, a three-way valve may be arranged at branch points between the oxidizing gas supply main pipe 23, and the first oxidizing gas valve 221, the second oxidizing gas valve 222, and the third oxidizing gas valve 223. A thermostat or the like available for temperature adjustment in addition to flow rate adjustment may be provided at the branch point. The first oxidizing off-gas discharge pipe 27 may be provided with an ejector, and the ejector may be used for adjusting a back pressure and adjusting a flow rate. The oxidizing gas distributor 22 may further include a pump for pressurizing the oxidizing gas. These other embodiments described above also apply to the fuel gas distributor 43. The fuel gas distributor 43 may include an injector for flow rate adjustment provided in each of the first fuel discharge gas pipe 52, the second fuel discharge gas pipe 53, and the third fuel discharge gas pipe 54. This also applies to the oxidizing gas distributor 22. The oxidizing gas-based circuit 20 may include a flow tube as a bypass between the oxidizing gas supply main pipe 23 and the oxidizing off-gas discharge main pipe 30.
(B8) In the above embodiment, the fuel cell system 100 includes one air compressor 21, one circulation pump 42a, and one circulation pump 62. In another embodiment, the fuel cell system 100 may include one supply source DA for at least one circuit among the oxidizing gas-based circuit 20, the fuel gas-based circuit 40, and the cooling-based circuit 60. As an example, the oxidizing gas-based circuit 20 may be configured to include a plurality of the air compressors 21 and at least one oxidizing gas distributor 22. Specifically, the fuel cell system 100 may be configured to include both a plurality of the fuel cell stacks 10 using one air compressor 21 in common and the fuel cell stack 10 using one air compressor 21 exclusive to the fuel cell stack 10. By providing the distributor DB in the fuel cell system 100, it becomes possible to reduce the number of the supply sources DA independently of a fluid type to achieve an aspect such as space saving.
(B9) In the processing during usual operation according to the above embodiment, the scavenging process is performed in the fuel cell stack 10 where a cell voltage is lower than the first reference voltage Vth1. In another embodiment, in the presence of a plurality of the fuel cell stacks 10 where cell voltages are lower than the first reference voltage Vth1, the scavenging process may be performed only in the fuel cell stack 10 where the cell voltage is the lowest. By doing so, a total flow rate of the reaction gas for the scavenging process is limited, making it possible to provide give preference to power generation in the fuel cell stack 10 where a cell voltage is equal to or greater than the first reference voltage Vth1. If it is required for fulfilling requested power to generate power to maximum output in the normal fuel cell stack 10 where a cell voltage is equal to or greater than the first reference voltage Vth1, the scavenging process may be suspended. Specifically, if there is no margin for implementation of the scavenging process, the scavenging process may be performed when requested power is low at such a level as will provide a margin for implementation of the scavenging process. In the scavenging process, the flow rate of only one of the fuel gas and the oxidizing gas may be increased.
(B10) In the processing during usual operation according to the above embodiment, if a judgment NO is made in step S32, the processing routine is finished. In another embodiment, a processing substance may be determined in such a manner that, if a judgment NO is made in step S32, the processing flow is returned to step S30 after passage of a predetermined first standby period of time. Likewise, in another embodiment, a processing substance may be determined in such a manner that, if a judgment NO is made in step S38, the processing flow is returned to step S30 after passage of a predetermined second standby period of time. The first standby period of time and the second standby period of time are some seconds, for example. The first standby period of time and the second standby period of time may be periods be equal to each other or may be periods differing from each other.
(B11) In the processing at the start of operation according to the above embodiment, a judgment as to whether to perform the warm-up operation is made about the three fuel cell stacks 10 entirely. In another embodiment, a judgment as to whether to perform the warm-up operation may be made about each of the three fuel cell stacks 10 individually using the respective temperature sensors 12 of these fuel cell stacks 10. In this case, in the presence of both the fuel cell stack 10 requiring the warm-up operation and the fuel cell stack 10 not requiring the warm-up operation, control may be exerted in such a manner as to start the usual operation in the fuel cell stack 10 not requiring the warm-up operation. This allows the fuel cell system 100 to start power generation early. In the presence of a plurality of the fuel cell stacks 10 requiring the warm-up operation, starting the warm-up operation in order of decreasing remaining life makes it possible to reduce variations in remaining life.
(B12) In the above embodiment, the reference environment is defined in terms of temperature. For defining the reference environment, a sweep current to be extracted from the fuel cell stack 10 may be used instead of temperature. More specifically, usual operation of sweeping a current equal to or less than 80% of a maximum output current in the fuel cell stack 10 may be set as the reference environment. In this case, a cumulative power generation time during usual operation of sweeping a current larger than 80% of the maximum output current is set as a cumulative power generation time in the high-load environment. The reference environment may be defined using both temperature and the sweep current.
(B13) In the above embodiment, the stress counter 86 records a cumulative power generation time in the high-load environment. In another embodiment, the stress counter 86 may record the number of times the fuel cell stack 10 has been actuated below the freezing temperature. If the reference temperature used as a basis for performing the warm-up operation is set to −10° C., if the fuel cell stack 10 is set to perform the warm-up operation at a temperature equal to or less than −10° C., and if a temperature at the fuel cell stack 10 is higher than −10° C., the usual operation is performed without performing the warm-up operation. Start of the usual operation in a state where a temperature at the fuel cell stack 10 is higher than −10° C. and lower than 0° C. is called start below the freezing temperature. Making the start below the freezing temperature develops deterioration of the fuel cell stack 10. For this reason, the fuel cell stack 10 having made the start below the freezing temperature a larger number of times is assumable to have a shorter remaining life. Such a method of calculating a remaining life is useful if locations of the plurality of fuel cell stacks 10 are separated from each other and temperatures at these fuel cell stacks 10 largely differ from each other, for example.
(B14) In the above embodiment, in step S26 of the processing at the start of operation, a judgment is made as to whether a battery voltage is greater than the switching voltage. In another embodiment, a judgment may be made as to whether a sweep current extracted from the fuel cell stack 10 is greater than a switching current. Specifically, a current may be used instead of a voltage in judging whether the fuel cell stack 10 generates power stably. In another case, both a voltage and a current may be used for the judgment.
(B15) In the above embodiment, electrical parallel connection is established between the plurality of fuel cell stacks 10. However, electrical series connection may be established between the plurality of fuel cell stacks 10. Furthermore, in the above embodiment, an average of temperatures from the three temperature sensors 12 is acquired as a temperature at the plurality of fuel cell stacks 10. In another embodiment, the fuel cell system 100 may include a temperature sensor that detects an outside air temperature and may acquire a temperature from this temperature sensor as a temperature at the plurality of fuel cell stacks 10, for example.

The present disclosure is not limited to the above embodiments and is able to be realized with various configurations without departing from the spirit thereof. When the technical features thereof are not described as required features in the present specification, they are able to be deleted, as appropriate. The present disclosure may be realized in the following aspects, for example.
(1) According to one aspect of the present disclosure, a fuel cell system is provided. The fuel cell system comprises: a plurality of fuel cell stacks; at least one supply source that supplies a fluid to the plurality of fuel cell stacks; a distributor that distributes the fluid supplied from the at least one supply source to each fuel cell stack of the plurality of fuel cell stacks in response to a distribution ratio; and a controller. The controller calculates a remaining life of each of the fuel cell stacks and determines the distribution ratio on the basis of the calculated remaining life. According to this aspect, as the distribution ratio is controlled on the basis of the calculated remaining life, variations in remaining life between the plurality of fuel cell stacks are reduced.
(2) In the fuel cell system according to the above aspect, the at least one supply source may include an oxidizing gas supply source that supplies an oxidizing gas, and a fuel gas supply source that supplies a fuel gas, the distributor may be provided for at least one of the oxidizing gas supply source and the fuel gas supply source, the plurality of fuel cell stacks may include a first fuel cell stack and a second fuel cell stack having the remaining life shorter than the remaining life of the first fuel cell stack, the controller may determine the distribution ratio such that a power generation start time of the first fuel cell stack is earlier than the power generation start time of the second fuel cell stack, and such that a power generation duration of the first fuel cell stack is longer than the power generation duration of the second fuel cell stack. According to this aspect, the power generation duration of the first fuel cell stack becomes longer than the power generation duration of the second fuel cell stack. During the power generation, load received by the first fuel cell stack is larger than load received by the second fuel cell stack. Thus, it is possible to reduce a difference between the remaining life of the first fuel cell stack and the remaining life of the second fuel cell stack.
(3) The fuel cell system according to the above aspect may comprise a temperature sensor that detects a temperature at the plurality of fuel cell stacks. If a detected temperature from the temperature sensor is lower than a predetermined reference temperature, the controller may perform warm-up operation in advance of usual operation where each of the fuel cell stacks is caused to operate at a reference operating point. The warm-up operation is operation where each of the fuel cell stacks is caused to operate at a low-efficient operating point resulting in lower efficiency than the reference operating point. For implementation of the warm-up operation, the controller may determine the distribution ratio such that a warm-up operation start time of the first fuel cell stack is earlier than the warm-up operation start time of the second fuel cell stack. According to this aspect, the first fuel cell stack finishes the warm-up operation and makes a transition to the usual operation in advance of the second fuel cell stack. Thus, an operating duration of the usual operation in the first fuel cell stack becomes longer than an operating duration of the usual operation in the second fuel cell stack. As a result, it is possible to reduce a difference between the remaining life of the first fuel cell stack and the remaining life of the second fuel cell stack.
(4) In the fuel cell system according to the above aspect, the at least one supply source may include a cooling water supply source that supplies cooling water, the fuel cell system may comprise a circulation flow path for causing the cooling water to circulate, the first fuel cell stack may be a fuel cell stack having the longest remaining life of the plurality of fuel cells, the controller may determine the distribution ratio at the cooling water supply source such that, during implementation of the warm-up operation in the first fuel cell stack, the cooling water is supplied to the first fuel cell stack and the cooling water is not supplied to a rest of the plurality of fuel cell stacks except for the first fuel cell stack, and the cooling water increased in temperature by the first fuel cell stack performing the warm-up operation may be caused to circulate only in the first fuel cell stack. According to this aspect, causing the cooling water to circulate only in the first fuel cell stack increases the temperature of the cooling water early, making it possible to warm up the first fuel cell stack efficiently.
(5) In the fuel cell system according to the above aspect, the at least one supply source may include an oxidizing gas supply source that supplies an oxidizing gas, and a fuel gas supply source that supplies a fuel gas, the distributor may be provided for at least one of the oxidizing gas supply source and the fuel gas supply source, each of the fuel cell stacks may include: a plurality of stacked cells; and a plurality of cell voltage sensors that detects a voltage on the basis of one, or two or more of the cells as a unit, the controller may perform usual operation where each of the fuel cell stacks is caused to operate at a reference operating point, and if the plurality of fuel cell stacks includes a low-voltage fuel cell stack where a cell voltage indicated by each cell voltage sensor of the plurality of cell voltage sensors is lower than a predetermined first reference voltage during the usual operation, the controller may determine the distribution ratio such that the flow rate of at least one of the oxidizing gas and the fuel gas to be supplied to the low-voltage fuel cell stack is greater than a corresponding flow rate at the reference operating point.

Generated water resulting from power generation reaction may be retained in the flow path for the fuel gas or in the flow path for the oxidizing gas in the fuel cell stack. In such a case, supply of the fuel gas or the oxidizing gas becomes insufficient. Hence, power is not generated sufficiently to reduce a cell voltage. According to this aspect, it is possible to supply the fuel gas or the oxidizing gas abundantly to a cell where insufficient supply of the fuel gas or the oxidizing gas is likely to occur so a cell voltage is low. By doing so, it becomes possible to remove the generated water retained in the flow path for the fuel gas or the flow path for the oxidizing gas.

The present disclosure may be realized in various types of aspects. For example, in addition to the fuel cell system, the present disclosure may be realized in aspects including a method of controlling a fuel cell system, a computer program for causing a computer to implement the control method, and a non-transitory and tangible recording medium in which the computer program is stored readably.

What is claimed is:

1. A fuel cell system comprising:
a plurality of fuel cell stacks;
at least one supply source that supplies a fluid to the plurality of fuel cell stacks;
a distributor that distributes the fluid supplied from the at least one supply source to each fuel cell stack of the plurality of fuel cell stacks in response to a distribution ratio; and
a controller configured to calculate a remaining life of each of the fuel cell stacks and determine the distribution ratio on the basis of the calculated remaining life.

2. The fuel cell system according to claim 1, wherein
the at least one supply source includes an oxidizing gas supply source that supplies an oxidizing gas, and a fuel gas supply source that supplies a fuel gas,
the distributor is provided for at least one of the oxidizing gas supply source and the fuel gas supply source,
the plurality of fuel cell stacks includes a first fuel cell stack and a second fuel cell stack having the remaining life shorter than the remaining life of the first fuel cell stack,
the controller determines the distribution ratio such that a power generation start time of the first fuel cell stack is earlier than the power generation start time of the second fuel cell stack, and such that a power generation duration of the first fuel cell stack is longer than the power generation duration of the second fuel cell stack.

3. The fuel cell system according to claim 2, comprising:
a temperature sensor that detects a temperature at the plurality of fuel cell stacks, wherein
if a detected temperature from the temperature sensor is lower than a predetermined reference temperature, the controller performs warm-up operation in advance of usual operation where each of the fuel cell stacks is caused to operate at a reference operating point, the warm-up operation being operation where each of the fuel cell stacks is caused to operate at a low-efficient operating point resulting in lower efficiency than the reference operating point, and
for implementation of the warm-up operation, the controller determines the distribution ratio such that a warm-up operation start time of the first fuel cell stack is earlier than the warm-up operation start time of the second fuel cell stack.

4. The fuel cell system according to claim 3, wherein
the at least one supply source includes a cooling water supply source that supplies cooling water,
the fuel cell system comprises a circulation flow path for causing the cooling water to circulate,
the first fuel cell stack is a fuel cell stack having the longest remaining life of the plurality of fuel cells,
the controller determines the distribution ratio at the cooling water supply source such that, during implementation of the warm-up operation in the first fuel cell stack, the cooling water is supplied to the first fuel cell stack and the cooling water is not supplied to a rest of the plurality of fuel cell stacks except for the first fuel cell stack, and the cooling water increased in temperature by the first fuel cell stack performing the warm-up operation is caused to circulate only in the first fuel cell stack.

5. The fuel cell system according to claim 1, wherein
the at least one supply source includes an oxidizing gas supply source that supplies an oxidizing gas, and a fuel gas supply source that supplies a fuel gas,
the distributor is provided for at least one of the oxidizing gas supply source and the fuel gas supply source,
each of the fuel cell stacks includes:
a plurality of stacked cells; and
a plurality of cell voltage sensors that detects a voltage on the basis of one, or two or more of the cells as a unit,
the controller performs usual operation where each of the fuel cell stacks is caused to operate at a reference operating point, and
if the plurality of fuel cell stacks includes a low-voltage fuel cell stack where a cell voltage indicated by each cell voltage sensor of the plurality of cell voltage sensors is lower than a predetermined first reference voltage during the usual operation, the controller determines the distribution ratio such that the flow rate of at least one of the oxidizing gas and the fuel gas supplied to the low-voltage fuel cell stack is greater than a corresponding flow rate at the reference operating point.
